(19) United States
(12) Patent Application Publication
(10) Pub. No.: US 2023/0194284 A1
(43) Pub. Date: Jun. 22, 2023

(54) METHOD, APPARATUS, AND COMPUTER PROGRAM PRODUCT FOR IDENTIFYING RESIDENCE LOCATION RECOMMENDATIONS

(71) Applicant: HERE Global B.V., Eindhoven (NL)

(72) Inventors: Jerome BEAUREPAIRE, Berlin (DE); Jens UNGER, Berlin (DE)

(21) Appl. No.: 17/645,100

(22) Filed: Dec. 20, 2021

(51) Int. Cl. G01C 21/34

(52) U.S. Cl. CPC G01C 21/3484; G01C 21/3476

(57) ABSTRACT

Provided herein is a method, apparatus, and computer program product for using isolines representing travel time or distance to points-of-interest to identify a recommended property location. Methods may include: determining an area of interest within a geographic region based on isolines computed from points-of-interest in point-of-interest categories identified as relevant to a user; determining exclusion areas within the area of interest; segmenting the area of interest less the exclusion areas into a plurality of candidate areas; calculating a score for each of the candidate areas, where the score for a candidate area is determined based on a subset of points-of-interest in the point-of-interest categories satisfying point-of-interest travel times relative to the candidate area established by isolines for the points-of-interest of the subset of points-of-interest; and generating a map for presentation on a graphical user interface identifying the candidate areas and a visual representation of respective scores of the candidate areas.

### TECHNOLOGICAL FIELD

Example embodiments described herein relate generally to generating recommendations for optimal residence locations, and more particularly, to using isolines representing travel time or distance to points-of-interest to identify a recommended property location.

### BACKGROUND

The selection of a property for living or visiting can be challenging, particularly when a person looking for the property is unfamiliar with an area. The number of locations where a property may be located can be daunting, particularly in larger metropolitan areas. While some neighborhoods or condominium complexes may generally be regarded as good places to live, these reputations are often based on opinions, and opinions differ based on the priorities of individuals. Thus, the definition of what is a good place to live is highly subjective and difficult to ascertain for a particular individual.

People can study locations and travel areas to get a feel for a location to determine if it is a place that they would like to live or visit; however, doing so for all available locations can be daunting and far too time consuming to be practical. Relying on advice from realtors or friends can impart bias from those individuals based on their preferences or based on their perceptions of another person's preferences. Thus, it is difficult to establish where to find a property to live in or stay temporarily with information sources that are conventionally available.

### BRIEF SUMMARY OF EXAMPLE EMBODIMENTS

At least some example embodiments are directed to generally to generating recommendations for optimal residence locations, and more particularly, to using isolines representing travel time or distance to points-of-interest to identify a recommended residence location. Embodiments may provide an apparatus including at least one processor and at least one memory including computer program code, the at least one memory and the computer program code may be configured to, with the processor, cause the apparatus to at least: determine an area of interest within a geographic region based on isolines computed from points-of-interest in point-of-interest categories identified as relevant to a user; determine exclusion areas within the area of interest; segment the area of interest less the exclusion areas into a plurality of candidate areas; calculate a score for each of the candidate areas, where the score for a candidate area is determined based on a subset of points-of-interest in the point-of-interest categories satisfying point-of-interest travel times relative to the candidate area established by isolines for the points-of-interest of the subset of points-of-interest; and generate a map for presentation on a graphical user interface identifying the candidate areas and a visual representation of respective scores of the candidate areas.

According to some embodiments, the exclusion areas within the area of interest include areas exceeding a maximum average price per unit area for at least one of residential rental rates or residential property prices. The exclusion areas within the area of interest include, in some embodiments, areas defined by map layers in map data, where the areas defined by map layers include one or more of: areas exceeding a maximum average ambient noise, areas exceeding a maximum average crime rate, areas failing to meet minimum average air quality standards, or areas zoned other than residential. The point-of-interest categories identified as relevant to a user are identified, in some embodiments, based on historic mobility data of the user. Causing the apparatus of some embodiments to calculate the score for each of the candidate areas further includes causing the apparatus to generate a weight for each point-of-interest category based on user preferences, where point-of-interest categories having a higher weight have greater influence on the score. The apparatus of an example embodiment is further caused to determine the weight for each point-of-interest category based on historic mobility data for the user.

According to certain embodiments, causing the apparatus to determine the area of interest within a geographic region based on isolines computed from points-of-interest in point-of-interest categories identified as relevant to the user includes causing the apparatus to determine the areas of interest within a geographic region based on isolines computed from points-of-interest in point-of-interest categories identified as relevant to the user and one or more individuals associated with the user. According to some embodiments, the point-of-interest categories identified as relevant to the user and one or more individuals associated with the user are identified based on historic mobility of the user and the one or more individuals associated with the user.

According to some embodiments, point-of-interest category-specific travel times relative to the candidate area further include point-of-interest category-specific travel times by point-of-interest category-specific travel modes, where the point-of-interest category-specific travel modes include one or more of walking, driving, using public transit, cycling, or a combination thereof. Causing the apparatus of an example embodiment to generate a map for presentation on a graphical user interface identifying the candidate areas and a visual representation of respective scores of the candidate areas includes causing the apparatus to generate a map of the geographic region including an overlay of the candidate areas within the area of interest and visually distinguish each candidate area based on a respective score for the respective candidate area, where visual distinction includes one or more of a color, a shade, or a transparency of the candidate area. The apparatus of an example embodiment is further caused to provide visual indications of points-of-interest in the point-of-interest categories identified as relevant to the user. The apparatus of an example embodiment is further caused to, in response to selection of a first candidate area, provide visual distinction of the points-of-interest in the point-of-interest categories identified as relevant to the user that contributed to the respective score for the first candidate area.

Embodiments provided herein include a computer program product including at least one non-transitory computer-readable storage medium having computer-executable program code instructions stored therein, the computer-executable program code instructions including program code instructions to: determine an area of interest within a geographic region based on isolines computed from points-of-interest in point-of-interest categories identified as relevant to a user; determine exclusion areas within the area of interest; segment the area of interest less the exclusion areas into a plurality of candidate areas; calculate a score for each of the candidate areas, where the score for a candidate area is determined based on a subset of points-of-interest in the point-of-interest categories satisfying point-of-interest travel times relative to the candidate area established by isolines for the points-of-interest of the subset of points-of-interest; and generate a map for presentation on a graphical user interface identifying the candidate areas and a visual representation of respective scores of the candidate areas.

According to some embodiments, the exclusion areas within the area of interest include areas exceeding a maximum average price per unit area for at least one of residential rental rates or residential property prices. The exclusion areas within the area of interest include, in some embodiments, areas defined by map layers in map data, where the areas defined by map layers include one or more of: areas exceeding a maximum average ambient noise, areas exceeding a maximum average crime rate, areas failing to meet minimum average air quality standards, or areas zoned other than residential. The point-of-interest categories identified as relevant to a user are identified, in some embodiments, based on historic mobility data of the user. The program code instructions of some embodiments to calculate the score for each of the candidate areas further include program code instructions to generate a weight for each point-of-interest category based on user preferences, where point-of-interest categories having a higher weight have greater influence on the score. The computer program product of an example embodiment further includes program code instructions to determine the weight for each point-of-interest category based on historic mobility data for the user.

According to certain embodiments, the program code instructions to determine the area of interest within a geographic region based on isolines computed from points-of-interest in point-of-interest categories identified as relevant to the user include program code instructions to determine the areas of interest within a geographic region based on isolines computed from points-of-interest in point-of-interest categories identified as relevant to the user and one or more individuals associated with the user. According to some embodiments, the point-of-interest categories identified as relevant to the user and one or more individuals associated with the user are identified based on historic mobility of the user and the one or more individuals associated with the user.

According to some embodiments, point-of-interest category-specific travel times relative to the candidate area further include point-of-interest category-specific travel times by point-of-interest category-specific travel modes, where the point-of-interest category-specific travel modes include one or more of walking, driving, using public transit, cycling, or a combination thereof. The program code instructions of an example embodiment to generate a map for presentation on a graphical user interface identifying the candidate areas and a visual representation of respective scores of the candidate areas include program code instructions to generate a map of the geographic region including an overlay of the candidate areas within the area of interest and visually distinguish each candidate area based on a respective score for the respective candidate area, where visual distinction includes one or more of a color, a shade, or a transparency of the candidate area. The computer program product of an example embodiment further includes program code instructions to provide visual indications of points-of-interest in the point-of-interest categories identified as relevant to the user. The computer program product of an example embodiment further includes program code instructions to, in response to selection of a first candidate area, provide visual distinction of the points-of-interest in the point-of-interest categories identified as relevant to the user that contributed to the respective score for the first candidate area. According to certain embodiments, a computer program product is provided including a computer program product comprising instructions which, when executed by a computer, cause the computer to carry out the operations described herein.

Embodiments provided herein include a method including: determining an area of interest within a geographic region based on isolines computed from points-of-interest in point-of-interest categories identified as relevant to a user; determining exclusion areas within the area of interest; segmenting the area of interest less the exclusion areas into a plurality of candidate areas; calculating a score for each of the candidate areas, where the score for a candidate area is determined based on a subset of points-of-interest in the point-of-interest categories satisfying point-of-interest travel times relative to the candidate area established by isolines for the points-of-interest of the subset of points-of-interest; and generating a map for presentation on a graphical user interface identifying the candidate areas and a visual representation of respective scores of the candidate areas.

According to some embodiments, the exclusion areas within the area of interest includes areas exceeding a maximum average price per unit area for at least one of residential rental rates or residential property prices. The exclusion areas within the area of interest include, in some embodiments, areas defined by map layers in map data, where the areas defined by map layers include one or more of: areas exceeding a maximum average ambient noise, areas exceeding a maximum average crime rate, areas failing to meet minimum average air quality standards, or areas zoned other than residential. The point-of-interest categories identified as relevant to a user are identified, in some embodiments, based on historic mobility data of the user. Calculating the score for each of the candidate areas further includes generating a weight for each point-of-interest category based on user preferences, where point-of-interest categories having a higher weight have greater influence on the score. The method of an example embodiment further includes determining the weight for each point-of-interest category based on historic mobility data for the user.

According to certain embodiments, determining the area of interest within a geographic region based on isolines computed from points-of-interest in point-of-interest categories identified as relevant to the user includes determining the areas of interest within a geographic region based on isolines computed from points-of-interest in point-of-interest categories identified as relevant to the user and one or more individuals associated with the user. According to some embodiments, the point-of-interest categories identified as relevant to the user and one or more individuals associated with the user are identified based on historic mobility of the user and the one or more individuals associated with the user.

According to some embodiments, point-of-interest category-specific travel times relative to the candidate area further include point-of-interest category-specific travel times by point-of-interest category-specific travel modes, where the point-of-interest category-specific travel modes include one or more of walking, driving, using public transit, cycling, or a combination thereof. Generating a map for presentation on a graphical user interface identifying the candidate areas and a visual representation of respective scores of the candidate areas includes, in some embodiments, generating a map of the geographic region including an overlay of the candidate areas within the area of interest and visually distinguishing each candidate area based on a respective score for the respective candidate area, where visual distinction includes one or more of a color, a shade, or a transparency of the candidate area. The method of an example embodiment further includes providing visual indications of points-of-interest in the point-of-interest categories identified as relevant to the user. The method of an example embodiment further includes, in response to selection of a first candidate area, providing visual distinction of the points-of-interest in the point-of-interest categories identified as relevant to the user that contributed to the respective score for the first candidate area.

Embodiments provided herein include an apparatus including: means for determining an area of interest within a geographic region based on isolines computed from points-of-interest in point-of-interest categories identified as relevant to a user; means for determining exclusion areas within the area of interest; means for segmenting the area of interest less the exclusion areas into a plurality of candidate areas; means for calculating a score for each of the candidate areas, where the score for a candidate area is determined based on a subset of points-of-interest in the point-of-interest categories satisfying point-of-interest travel times relative to the candidate area established by isolines for the points-of-interest of the subset of points-of-interest; and means for generating a map for presentation on a graphical user interface identifying the candidate areas and a visual representation of respective scores of the candidate areas.

According to some embodiments, the exclusion areas within the area of interest includes areas exceeding a maximum average price per unit area for at least one of residential rental rates or residential property prices. The exclusion areas within the area of interest include, in some embodiments, areas defined by map layers in map data, where the areas defined by map layers include one or more of: areas exceeding a maximum average ambient noise, areas exceeding a maximum average crime rate, areas failing to meet minimum average air quality standards, or areas zoned other than residential. The point-of-interest categories identified as relevant to a user are identified, in some embodiments, based on historic mobility data of the user. The means for calculating the score for each of the candidate areas further includes means for generating a weight for each point-of-interest category based on user preferences, where point-of-interest categories having a higher weight have greater influence on the score. The apparatus of an example embodiment further includes means for determining the weight for each point-of-interest category based on historic mobility data for the user.

According to certain embodiments, the means for determining the area of interest within a geographic region based on isolines computed from points-of-interest in point-of-interest categories identified as relevant to the user includes means for determining the areas of interest within a geographic region based on isolines computed from points-of-interest in point-of-interest categories identified as relevant to the user and one or more individuals associated with the user. According to some embodiments, the point-of-interest categories identified as relevant to the user and one or more individuals associated with the user are identified based on historic mobility of the user and the one or more individuals associated with the user.

According to some embodiments, point-of-interest category-specific travel times relative to the candidate area further include point-of-interest category-specific travel times by point-of-interest category-specific travel modes, where the point-of-interest category-specific travel modes include one or more of walking, driving, using public transit, cycling, or a combination thereof. The means for generating a map for presentation on a graphical user interface identifying the candidate areas and a visual representation of respective scores of the candidate areas includes, in some embodiments, means for generating a map of the geographic region including an overlay of the candidate areas within the area of interest and means for visually distinguishing each candidate area based on a respective score for the respective candidate area, where visual distinction includes one or more of a color, a shade, or a transparency of the candidate area. The apparatus of an example embodiment further includes means for providing visual indications of points-of-interest in the point-of-interest categories identified as relevant to the user. The apparatus of an example embodiment further includes, in response to selection of a first candidate area, means for providing visual distinction of the points-of-interest in the point-of-interest categories identified as relevant to the user that contributed to the respective score for the first candidate area.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of an example embodiment described herein;

FIG. 2 is a block diagram of an apparatus that may be specifically configured in accordance with an example embodiment of the present disclosure;

FIG. 3 illustrates a process for creating a mobility model or mobility graph of a user according to an example embodiment of the present disclosure;

FIG. 4 illustrates a boundary of areas within the geographic region that satisfy at least minimum criteria for residence locations based on the user preferences and the isolines generated by embodiments described herein according to an example embodiment of the present disclosure;

FIG. 5 illustrates an exclusion zone within the boundary within the geographic region according to an example embodiment of the present disclosure;

FIG. 6 illustrates an example embodiment in which the areas within the boundary are broken into polygon areas according to an example embodiment of the present disclosure;

FIG. 7 illustrates a table of point-of-interest categories and a time to reach those point-of-interest categories based on a mode of travel according to an example embodiment of the present disclosure;

FIG. 8 illustrates a table of point-of-interest categories, a time to reach those point-of-interest categories based on a mode of travel, and an importance of each category to a user according to an example embodiment of the present disclosure;

FIG. 9 illustrates a table of point-of-interest categories and candidate areas scored according to their respective access to points-of-interest according to an example embodiment of the present disclosure;

FIG. 10 illustrates a table of point-of-interest categories together with a desired travel time and an actual travel time according to an example embodiment of the present disclosure;

FIG. 11 illustrates a graphical representation of candidate areas and their respective scores according to an example embodiment of the present disclosure;

FIG. 12 illustrates a user interface of candidate areas and their scores according to an example embodiment of the present disclosure;

FIG. 13 illustrates another user interface of candidate areas and their scores according to an example embodiment of the present disclosure; and

FIG. 14 is a flowchart of a method for generating scores for candidate areas for property locations based on user preferences according to an example embodiment of the present disclosure.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Methods, apparatus, and computer program products are provided in accordance with an example embodiment in order to generating recommendations for optimal residence locations, and more particularly, to using isolines representing travel time or distance to points-of-interest to identify a recommended residence location. Selection of a location for a person to reside is necessarily specific to an individual or family based on their priorities and their needs. While general location recommendations may be apparent, identifying specific locations that satisfy the preferences and needs of an individual or family can be complex and difficult to quantify. Embodiments described herein identify the preferences and needs of an individual or family and use those preferences and needs to generate recommendations for specific areas within a geographic region that are well suited for the individual or family. Further, certain embodiments generate scores for specific areas that reflect how well the specific areas satisfy criteria established by the individual or family. Beyond locations proximate to a place of work or a school, embodiments described herein consider all relevant points-of-interest and methods of reaching those points-of-interest in establishing a score for an area to establish whether the area is well suited for a residence.

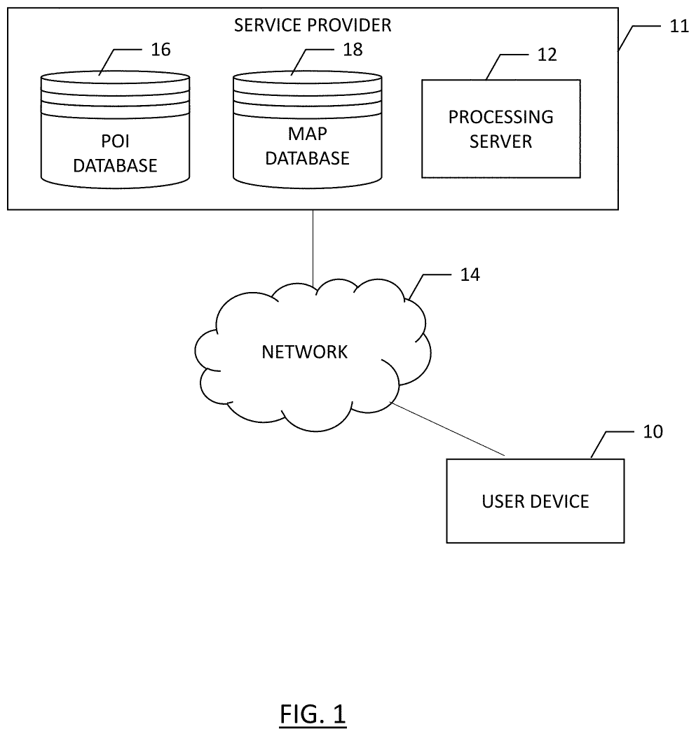

To generate recommendations for residence locations and quantifying those recommendations, a system as illustrated in FIG. 1 may be used. FIG. 1 illustrates a communication diagram of an example embodiment of a system for implementing example embodiments described herein. The illustrated embodiment of FIG. 1 includes a service provider 11, a processing server 12, a map database 18, and a POI database 16. As shown, the service provider 11 may be in communication via a network 14, such as a wide area network, such as a cellular network, the Internet, or a local area network. However, the service provider 11 may be in communication with the other elements of the system in other manners, such as via direct connection through direct communications between the map services provider 11 and data sources.

Examples of the probe data sources as described herein include a user device 10 associated with a user. The user device 10 may be embodied by a number of different devices including mobile computing devices, such as a personal digital assistant (PDA), mobile telephone, smartphone, laptop computer, tablet computer, vehicle navigation system, infotainment system, in-vehicle computer, personal computer, or any combination of the aforementioned.

The processing server 12 of the service provider 11 may also be embodied by a computing device and, in one embodiment, is embodied by a web server. Additionally, while the system of FIG. 1 depicts a single service provider 11 and a single user device 10, systems of example embodiments may include any number of service providers, mobile devices, any number of databases (including map databases, POI databases, or other data repositories), and any number of processing servers, which may operate independently or collaborate to support activities of the embodiments described herein.

The map database 18 may include one or more databases and may include information such as geographic information relating to road networks, points-of-interest, buildings, etc. Further, the map database 18 may store therein historical dynamic population or mobility data, such as historical traffic data, mobile device data, monitored area data (e.g., closed-circuit television), or the like. Thus, the map database 18 may be used to facilitate the quantifying and measuring of human mobility within defined geographic regions and sub-regions to establish familiarity with a geographic region. The map database 18 optionally further includes historic traffic data such that travel times between locations within the map at different times of day or different epochs can be estimated with a high degree of accuracy.

The point-of-interest database 16, which may be embodied by the map database 18 in some embodiments, may include information pertaining to any or all buildings, businesses, tourist attractions, restaurants, memorials, parks, or any type of place a user may seek out to visit. The information may include location, operating hours, user reviews, type of POI (e.g., specific cuisine for a restaurant, specific type of retail store, etc.), POI summary, POI website, POI contact information, POI licensing information, etc. The POI database may thus include any information that may relate to POIs and may be updated periodically by the POIs themselves (e.g., a business owner changing store hours, or a restaurant owner changing menus) or updated based on a data harvesting operation that crawls publicly available information to obtain updates.

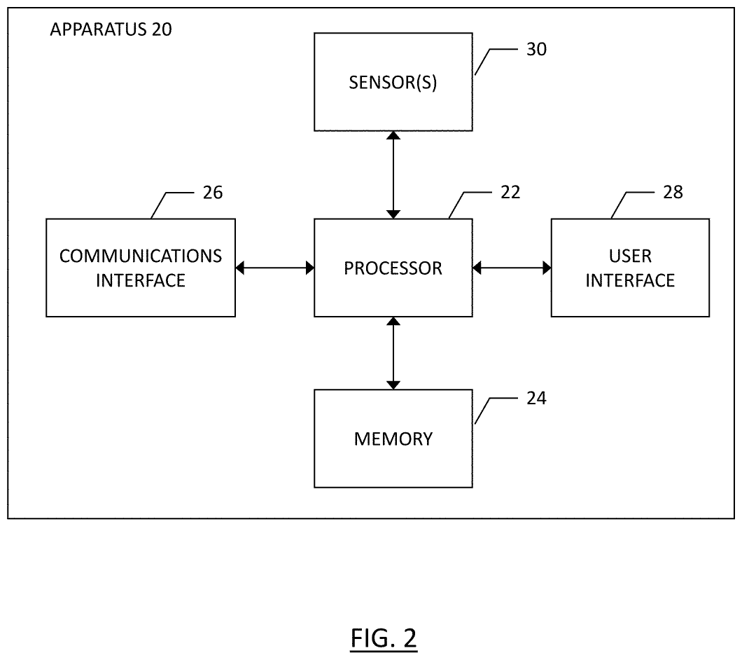

Regardless of the type of device that embodies the local user device 10, the user device may be embodied as an apparatus 20 as shown in FIG. 2. In this regard, the apparatus 20 may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device 24 may include, for example, one or more volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus 20 to carry out various functions in accordance with an example embodiment of the present invention. For example, the memory device 24 could be configured to buffer input data for processing by the processor 22. Additionally or alternatively, the memory device could be configured to store instructions for execution by the processor.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 24 or otherwise accessible to the processor 22. Alternatively or additionally, the processor 22 may be configured to execute hard coded functionality. As such, whether configured by hardware or software methods, or by a combination thereof, the processor 22 may represent an entity (e.g., physically embodied in circuitry) capable of performing operations according to an embodiment of the present invention while configured accordingly. Thus, for example, when the processor 22 is embodied as an ASIC, FPGA or the like, the processor 22 may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device (e.g., a head-mounted display) configured to employ an embodiment of the present invention by further configuration of the processor 22 by instructions for performing the algorithms and/or operations described herein. The processor 22 may include, among other things, a clock, an arithmetic logic unit (ALU) and logic gates configured to support operation of the processor 22. In one embodiment, the processor 22 may also include user interface circuitry configured to control at least some functions of one or more elements of the user interface 28.

Meanwhile, the communication interface 26 may include various components, such as a device or circuitry embodied in either hardware or a combination of hardware and software that is configured to receive and/or transmit data between a computing device (e.g. user device 10) and a processing server 12. In this regard, the communication interface 26 may include, for example, an antenna (or multiple antennas) and supporting hardware and/or software for enabling communications wirelessly. Additionally or alternatively, the communication interface 26 may include the circuitry for interacting with the antenna(s) to cause transmission of signals via the antenna(s) or to handle receipt of signals received via the antenna(s). For example, the communications interface 26 may be configured to communicate wirelessly with a head-mounted display, such as via Wi-Fi (e.g., vehicular Wi-Fi standard 802.11p), Bluetooth, mobile communications standards (e.g., 3G, 4G, or 5G) or other wireless communications techniques. In some instances, the communication interface 26 may alternatively or also support wired communication. As such, for example, the communication interface 26 may include a communication modem and/or other hardware/software for supporting communication via cable, digital subscriber line (DSL), universal serial bus (USB) or other mechanisms. For example, the communication interface 26 may be configured to communicate via wired communication with other components of a computing device.

The user interface 28 may be in communication with the processor 22, such as the user interface circuitry, to receive an indication of a user input and/or to provide an audible, visual, mechanical, or other output to a user. As such, the user interface 28 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface 28 may also be in communication with the memory 24 and/or the communication interface 26, such as via a bus.

The communication interface 26 may facilitate communication between different user devices and/or between the processing server 12 and user device 10. The communications interface 26 may be capable of operating in accordance with various first generation (1G), second generation (2G), 2.5G, third-generation (3G) communication protocols, fourth-generation (4G) communication protocols, fifth-generation (5G) communication protocols, Internet Protocol Multimedia Subsystem (IMS) communication protocols (e.g., session initiation protocol (SIP)), and/or the like. For example, a mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like.

The apparatus 20 of example embodiments, particularly when embodying a mobile user device, may further include one or more sensors 30 which may include location sensors, such as global positioning system (GPS) sensors, sensors to detect wireless signals for wireless signal fingerprinting, sensors to identify an environment of the apparatus 20 such as image sensors for identifying a location of the apparatus 20, or any variety of sensors which may provide the apparatus 20 with an indication of location.

While the apparatus 20 is shown and described to correspond to a user device 10, embodiments provided herein may include a user device that may be used for a practical implementation of embodiments of the present disclosure. For example, such an apparatus may include a laptop computer, desktop computer, tablet computer, mobile phone, or the like. Each of which may be capable of providing a graphical user interface (e.g., presented via display or user interface 28) to a user for interaction with a map providing mobility information, navigation information, point of interest information, etc. for geographic regions as described further below. Embodiments of the apparatus may include components similar to those as shown in FIG. 2 through which a user may interact with mobility data presented on the display of a user interface for a device, such as apparatus 20.

Embodiments described herein relate to generating recommendations for a residential location for a user. The “user” as defined herein may be an individual person or the “user” may represent a group, such as a family, that share a residential location. Thus, the “user” as described herein reflects the person or people for which a residential location is sought. Embodiments described herein use the needs and preferences of a user, where those needs and preferences may be the needs and preferences of an individual or of the group of people for which a single residential location is sought.

Mobility data, as described herein, is data reflecting the movements of one or more people as they travel within a geographic area. This mobility data may be collected, for example, through a device, such as user device 10. Mobility data may fundamentally include location information of the person or object to which it is associated. Mobility data can provide a location and timestamp indicating a time at which the user was at the location. This data can provide movement patterns of a user and identify contexts of location. For example, mobility data can include dwell time or time spent at different locations or points-of-interest and a frequency of such visits. This mobility data can identify points-of-interest or categories of points-of-interest that are of importance to a user's routine. Mobility data can establish that a user visits a school each day to drop off a child and proceeds to a work location where they spend most of their workday before returning home. Mobility data can further identify activities that a user enjoys, such as running or cycling along a river. Mobility data can be collected to identify a wide variety of aspects of a user's daily life and be useful for embodiments of the present disclosure in identifying a location to reside.

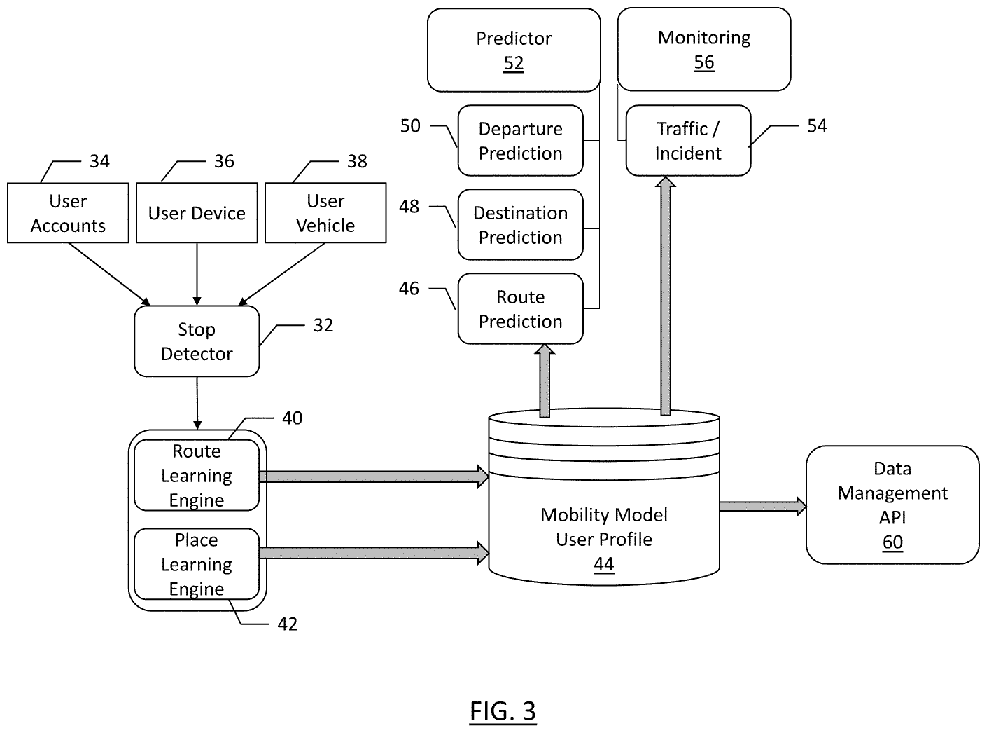

FIG. 3 illustrates an example embodiment of a process for creating a mobility model or mobility graph of a user. Data is collected by the stop detector 32, such as through a user device 36 (e.g., a mobile phone), a user vehicle 38 (e.g., through a navigation system or ADAS), user accounts 34 (e.g., credit/debit card transactions, user log-ins such as at a gym, etc.). This data provides an indication of the patterns of a user including where they spend their time, how they get there, and what interests a user has. The stop detector can feed this information to a route learning engine 40 and a place learning engine 42. The route learning engine 40 can process the data collected by the stop detector 32 to determine how a user travels between destinations. For example, if a user walks to a supermarket, what path they take to do so. Routes can be learned for driving to/from a work location and for other destinations. This establishes the movement patterns of a user. The place learning engine 42 can identify the locations where a user visits, and can identify types of points-of-interest visited by a user. The frequency of visits can also be established to help understand the preferences of a user. For example, if a user visits a coffee shop eight times per week, it is evident that a coffee shop point-of-interest category may be very important to that user.

The route learning engine 40 and the place learning engine 42 provide data to a mobility model user profile that aggregates the paths that a user travels and the locations they visit. This information can be used by a predictor 52 to predict routes by route predictor 46, destination predictions 48, and departure predictions 50. A route predictor 46 may predict that if a user is departing their home on a Monday morning, they may be heading to work, such that their typical route to work may be predicted including any waypoints (e.g., at a coffee shop). The destination predictor 48 may predict that work is a destination along with any waypoints based on their historical patterns. Departure prediction 50 may identify a time at which they are likely to leave their home and proceed along the predicted route to the predicted destination. Monitoring 56 may include monitoring a user's mobility model for anomalies in their movement patterns and learning why those movements may have changed. Traffic/incident 54 identifier may identify that an accident has occurred along a typical route to work, such that an alternative path may be taken. The mobility model user profile 44 provides information to a data management API 60 for use in applications such as the embodiments described herein.

Mobility data is subject to data privacy rules and regulations and is highly protected and safeguarded against adversaries. Further, users may choose which information or mobility data they wish to share with various entities. The present disclosure will not describe in detail how privacy concerns are addressed with respect to mobility data, but will describe how mobility data can be used provided a user permits sharing of some or all of their mobility data in using a service provided by embodiments of the present disclosure.

When choosing a location to reside various factors are considered. Generally there are apparent preferences, such as within a predefined distance or commute time to a place of work. However, far more factors contribute to the satisfaction a user may have with a residential location. A residence, as described herein, is a location where a user (person or people) live. A residence can include a single family home, multi-family home, apartment, or the like. Further, a residence can be for any period of time including temporary housing (e.g., days, weeks, months) or long term housing (e.g., years). Embodiments described herein algorithmically determine recommendations for areas to find a residence individualized for a user.

According to an example embodiment described herein, a user identifies points-of-interest that they would like to be near. These points-of-interest can represent their preferences and/or a combination of preferences from those associated with determining where to find a residence, such as members of the user's household. These points-of-interest can be identified by category (e.g., restaurants, retail shopping, grocery stores, etc.) or specific to a single point-of-interest (e.g., a workplace, a school, etc.). Further, a user can identify a weight to assign each of these points-of-interest or categories of points-of-interest. A place of work, for example, may have a very high weight as it is a destination a user may travel to five times per week. A specific church may have a relatively lower weight if a user travels only once per week to the destination. These preferences are used to establish candidate areas for residence for the user.

While a user may specify their preferences, embodiments provided herein can identify user preferences based on historical travel of the user. A user may specify some or all of their preferences, or in some embodiments, preferences may be identified automatically through the travel trends of the user. For example, a user device 10 can be used to track the location history of a user. If the user visits a specific location multiple times per week, that location may be identified as a heavily weighted point-of-interest. If a user visits retail stores regularly, a retail store category of point-of-interest may be given a relatively high weight. Embodiment can therefore learn a user's preferences based on their mobility data and use these preferences to identify recommendations for candidate areas for a residence as described further below.

According to an example embodiment in which multiple users are involved in determining where to find a residence, multiple user preferences may be considered. In such an embodiment, user preferences may be considered from all persons associated with the new residence. Further, user preferences may be weighted. For example, parent's preferences may be weighted more heavily than preferences of children in a household. In another example embodiment, if a user is seeking a residence and anticipating roommates, the user could have the preferences of the roommates or potential roommates considered in the selection. This can be performed by selecting individuals for which preferences should be considered, and assigning weights to the preferences of different individuals based on the primary user's (e.g., the home buyer or primary renter, for example) selections. The preferences of an individuals when multiple individuals are considered in establishing the optimal location for a residence may be ranked by the individual or automatically (e.g., by frequency of visits from the person's mobility history) such that weighting of multiple people considers what is most important to each individual in combining the preferences of the people.

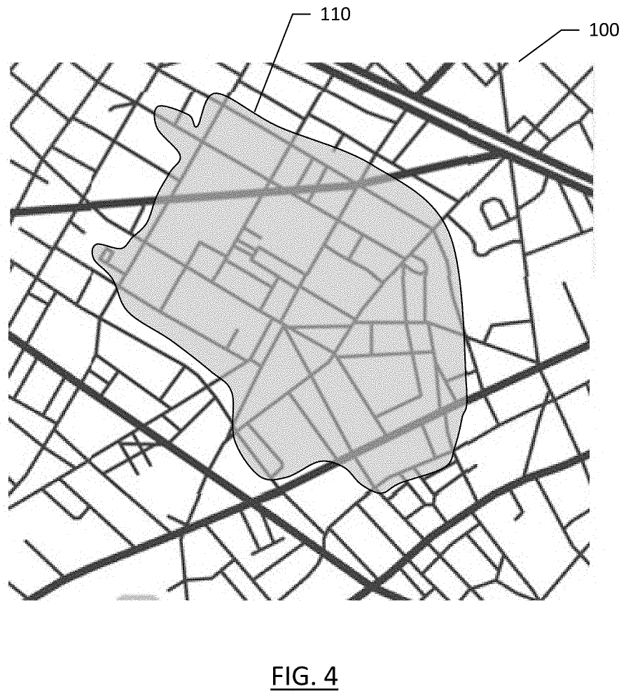

Based on the user preferences and potentially preferences of other persons impacted by the location of the residence, whether entered by a user, learned by a device (e.g., user device 10), or a combination thereof, isolines are generated by example embodiments described herein from points-of-interest to areas within a geographic region. FIG. 4 illustrates a boundary 110 of areas within the geographic region 100 that satisfy at least minimum criteria for residence locations based on the user preferences and the isolines generated by embodiments described herein from points-of-interest to areas within the geographic region 100. Isolines may be limited to a specific distance between the point-of-interest and an area, or a travel time between the point-of-interest and an area. Optionally, the minimum criteria that may be set to generate the boundary shown in FIG. 4 may be a commute time to a destination, such as a place of work. Work locations often dictate where a person may live, such that the first and potentially only initial criteria may include a commute time to a work location, where isolines to the work destination are used to define the boundary within which a user can commute to work within a predefined time. Additional minimum criteria may be established to limit the boundary within the geographic region of areas that can be considered for candidate areas for a place of residence. For example, a user may regularly run along a river, use a river for recreation (e.g., kayaking), or the like, such that areas only within a predetermined distance of a river may be considered. Similarly, if a user regularly visits a beach, only areas within a predetermined travel time of a beach may be within the boundary established. These criteria can be established by a user, or generated automatically through mobility data of the user collected by a mobile device, for example.

The point or points-of-interest associated with each isoline between an area and the respective point-of-interest are given weights based on the user criteria which is user generated, automatically generated, or a combination thereof as described above. Further, an exclusion zone is used in certain embodiments to exclude certain areas within the geographic region for various reasons. Exclusion zones may be established based on user preferences or established based on certain criteria. The exclusion zone may include, for example, a city center which may have concentrated points-of-interest and therefore relatively high scores in terms of proximity and availability of points-of-interest, but may not be desirable for the user. Exclusion zones can include certain areas where prices are relatively very high per square foot and may be less desirable to a user as they cannot afford sufficient living space. Exclusion zones can optionally include areas with low public transit availability.

Areas of a geographic region can be excluded based on certain area information included in a layer of information, such as a map layer. According to an example embodiment, a map layer of price-per-square-foot of real estate or rental rate-per-square-foot (or more generally, price per unit area) may be correlated with geographic areas, and a user may select prices within a predetermined range, or below a predetermined maximum which then excludes areas of the map that are above that predetermined price. A map layer may include zoning information, such that commercial-zoned for industrial-zoned areas may be excluded from consideration as residential locations. Other criteria may include air quality indices for an area, where air quality below a predetermined average may be excluded. Such areas of low air quality may be in areas near industrial-zoned areas, or in areas that have a topography that is conducive to low air quality (e.g., low altitude areas of an industrial city). Similarly, ambient noise map layer overlays may be available that identify noise-corridors along major highways and along landing approach or take-off paths proximate an airport, where ambient noise levels above a predetermined maximum may be excluded from consideration. Another map layer that can be employed for exclusion zones is a crime rate map layer, where crime rates (e.g., violent crime per 100,000 people annually) can be used to exclude certain areas. Each of these exclusion zones may be available to a user to select or deselect to increase or decrease the number of candidate ares for a residence. Exclusion zones can optionally be entirely excluded from consideration; however, in other embodiments, exclusion zones can be very heavily negatively weighted, such that in a comprehensive search for a location for a residence, a factor that would ordinarily be exclusionary may be overcome by the other factors of a candidate area.

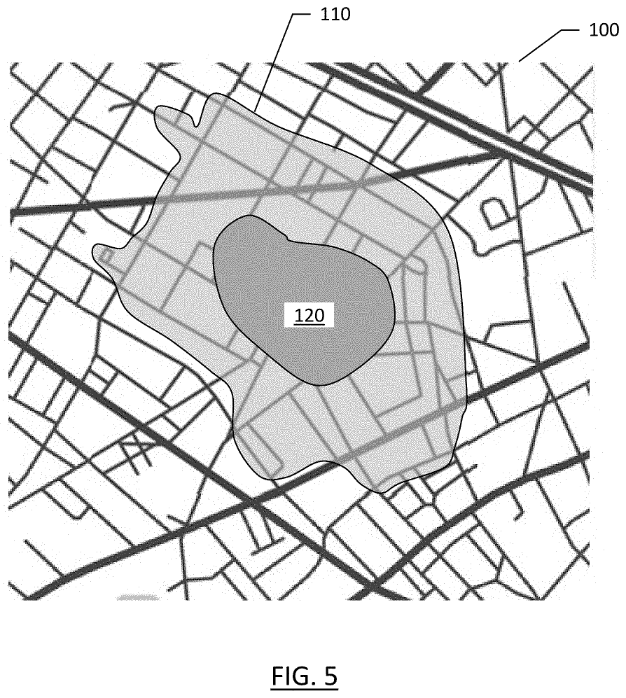

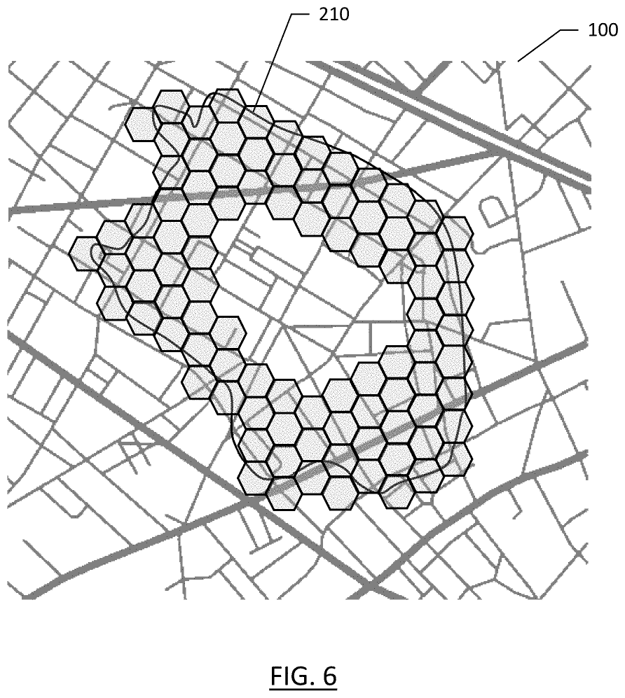

FIG. 5 illustrates an exclusion zone 120 within the boundary 110. The establishment of general overall areas within a geographic region can be used as a first step in identifying desirable locations for a residence. These isolines reflect a minimum criteria for a desirable area for a residential location. A second step of example embodiments segments the area identified through the isoline generation into candidate areas defined by polygons. The areas within the boundary 110 and outside of the exclusion zone 120 (where present) can be segmented by polygons that serve to generalize the desirability of the area within the polygon. FIG. 6 illustrates an example embodiment in which the areas within the boundary 110 are broken into polygon areas 210, which in the illustrated embodiment are hexagons. For each of these polygon areas or “candidate areas” that are candidates for locating a residence, a score can be computed that reflects the access and proximity to points-of-interest. The isolines from points-of-interest to each polygonal candidate area may be used to establish the score for a reflective candidate area. These areas may be, for example, one hundred meters across.

Embodiments described herein employ a two-step process of first establishing an area within a geographic region that meets minimum criteria, applying any exclusion zones (or weighting based on exclusion zones), and then segments the area within the geographic region into candidate areas. This enables faster processing and lower latency in identifying candidate areas and generating scores for the candidate areas. Embodiments could omit the first step by dividing an area into candidate areas and scoring all candidate areas; however, this would require greater processing capacity and will be more computationally expensive. Embodiments described herein provide a method of identifying candidate areas and generating a score for these areas based on an analysis of various properties of the candidate areas, such as distances (e.g., physical distance or travel time) to different points-of-interest or categories of points-of-interest even employing different travel modes to establish travel times. Embodiments are not capable of being performed in the human mind for a variety of reasons, such as the complexity of establishing scores for each of a plurality of candidate areas, where each score is generated based on map data used to establish point-of-interest distances to a respective area in a variety of categories, and subsequently scoring each area based on this analysis.

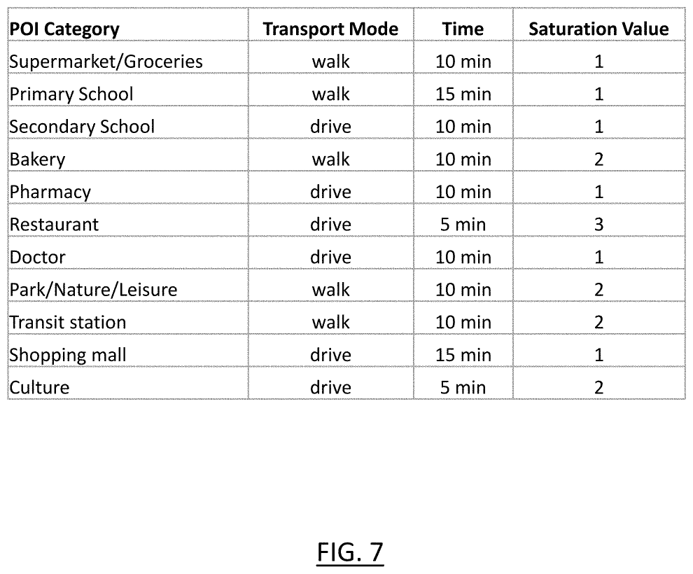

The calculation of a score for each candidate area can be performed based on the points-of-interest, their weights, and their proximities. Example embodiments provided herein algorithmically identify the candidate locations that most closely correspond to the preferences of a user. The candidate locations are scored based on a set of points-of-interest or point-of-interest categories that should be reached within a predefined time using a given transport method. FIG. 7 illustrates a table of point-of-interest categories and a time to reach those point-of-interest categories based on a mode of travel. A saturation value is also included for points-of-interest, such as a pharmacy with a saturation value of “1”, since a plurality of pharmacies proximate to a location are not of substantially increased benefit, and a saturation limit avoids skewing a score of a location based on points-of-interest of lower interest or value.

The score can be calculated through binary point-of-interest category satisfaction, where, with reference to the table of FIG. 7, a primary school within a fifteen minute walk would satisfy the point-of-interest category, while a primary school beyond a fifteen minute walk fails to satisfy the point-of-interest category. Optionally, a point-of-interest category can be afforded a degree of satisfaction of a point-of interest category. For example, a secondary school that is a fifteen minute drive from an area does not satisfy the point-of-interest category of the table of FIG. 7, but partial satisfaction (e.g., fifty percent) may be afforded the point-of-interest category due to the secondary school being a bit further away than ideal. Further, a bonus to a degree of satisfaction may be provided to a point-of-interest category when the category is met well within the distance metric. For example, a bakery that is within a two-minute walk may afford the bakery point-of-interest category a bonus to the satisfaction of the category which may increase a score of an area.

A point-of-interest requirement table is employed in an example embodiment with required points-of-interest or categories thereof identified either by a user, by a standard set of point-of-interest categories, or through learning of mobility data of a user. A point-of-interest requirement table can be used as an input that defines known needs and requirements of a user. A point-of-interest table can be established based on the theory of the fifteen-minute-city where a user can reach their necessary destinations within fifteen minutes. In this theory, the points-of-interest within fifteen minutes of travel must satisfy six basic social functions: living, working, supplying, caring, learning, and enjoying. The points-of-interest can generally be binned to these six primary functions, or separately categorized for a more granular scoring of a candidate area. A point-of-interest requirement table may be automatically generated (e.g., using the six categories above), generated based on user mobility history as described further below, manually generated, or a combination thereof.

A user may generate such a table based on a template or a user interface to present options to the user. Embodiments optionally use the user's mobility data to identify what points-of-interest are of importance to a user such that a point-of-interest requirement table could be automatically generated from the mobility data. An automatically populated point-of-interest requirement table can optionally be presented to a user who can manually modify any particular categories as needed. For example, while a primary school may be visited every weekday by a parent, if the parent is looking for a location of a new residence as the child is finishing their time at the primary school, the primary school proximity may no longer be a point-of-interest requirement.

Automation of point-of-interest requirement tables can be beneficial to a user as they avoid having a user manually select point-of-interest categories, regular transport modes, and time metrics. Further, an automated point-of-interest requirement table based on mobility data may capture points-of-interest not considered by a user. The automated point-of-interest requirement table can optionally serve as a baseline set of data that a user could use as minimum requirements for a new residence location. Such an automated point-of-interest requirement table can define a user's current residence score, and seek to improve upon that score in a new residence location.

The mobility data of a user can be used by example embodiments described herein to determine a set of key points-of-interest that should be reachable along with a maximum isoline value (e.g., maximum time and/or distance to reach the point-of-interest). The key points-of-interest could include, for example, a work location for a user, a favorite restaurant, a gym, a school, etc. If a user reached each of the key points-of-interest within a predetermined amount of time (e.g., within forty five minutes), this value may be used as a baseline from which key points-of-interest should not exceed. Reduced travel time to key points of interest in a new residence location can improve a person's quality of life. When multiple people's preferences are to be considered for the location of a residence, the mobility data from the multiple users can be considered in establishing the set of key points-of-interest that should be reachable. In this way, mobility graphs of multiple people can be combined or merged to determine the suitability of a location for a residence. As noted above, the weight afforded to the preferences of individuals when multiple individuals are considered in establishing a residential location can be established through user selection or through profiles of the users. Profiles, such as adults of a household can be afforded a higher weight than children of a household, for example. The mobility graphs for multiple people can be aggregated or separately scored to consider the preferences of all people associated with the residence. The preferences of multiple people may be used to generate a table of points-of-interest and weight each of those point-of-interest categories based on the combined, weighted preferences.

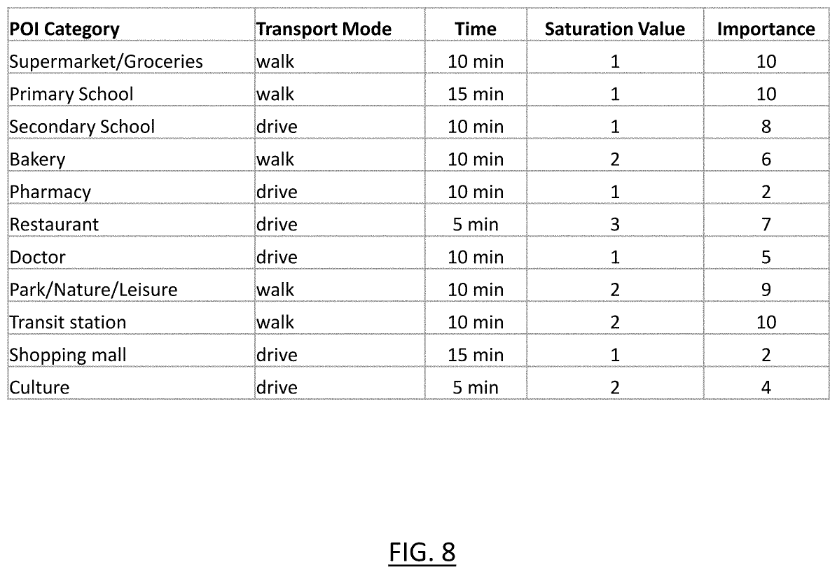

The table of FIG. 7 can be employed as a binary yes/no as to the presence of a point-of-interest satisfying the respective categories defined on each line. Such a binary scoring system can establish a total point score for point-of-interest categories satisfied by a candidate area. However, such a binary scoring system may not capture the importance of various categories to a user. FIG. 8 illustrates a table with a weight category that defines the importance of a category for a particular user. This importance weight can be automatically defined, manually defined, or a combination thereof. To automatically identify the importance of a point-of-interest category, user mobility data may be used to establish how often a point-of-interest category is visited. If the point-of-interest category is regularly visited, the proximity of a point-of-interest in the respective category may be deemed very important. For example, a supermarket, primary school, and transit station are all deemed very important to a user represented by the table of FIG. 8, while a pharmacy and shopping mall are least important to the user. A weighted table such as that of FIG. 8 can provide a more granular score to a candidate area and more closely approximate the needs of a user based on the importance of certain points-of-interest.

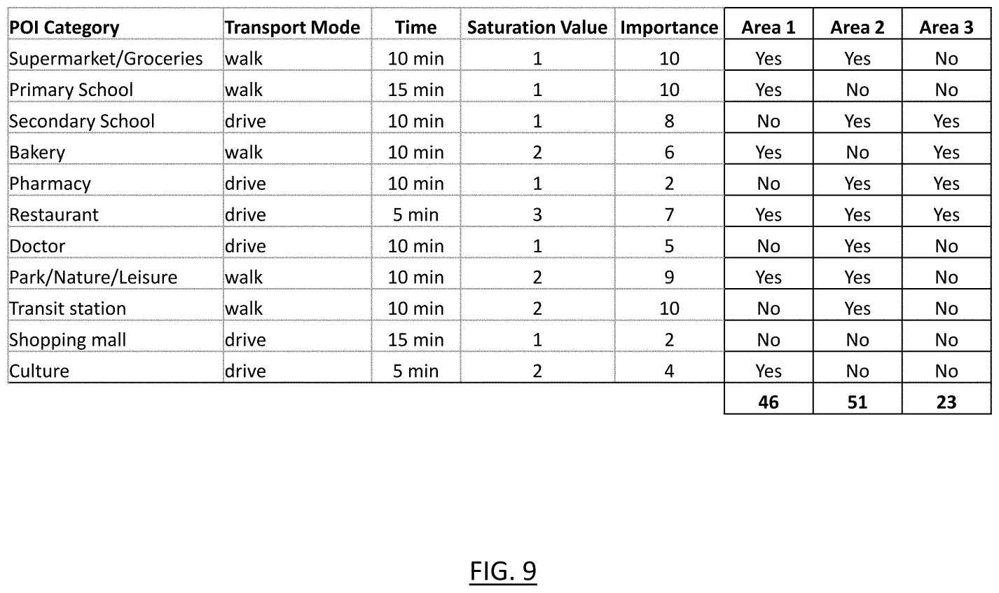

FIG. 9 illustrates a table including the scoring for three candidate areas. As illustrated, each point-of-interest category includes a transport mode and time within which the point-of-interest should be reached by the transport mode. The table of FIG. 8 further includes the saturation value and importance. If a point-of-interest satisfies a point-of-interest category for a particular candidate area (e.g., Area 1), the score can be incremented with the score weighted by the importance. The more important a point-of-interest category is to a user, the greater the weight in the score such that a user's preferences influence their personal score for a candidate area.

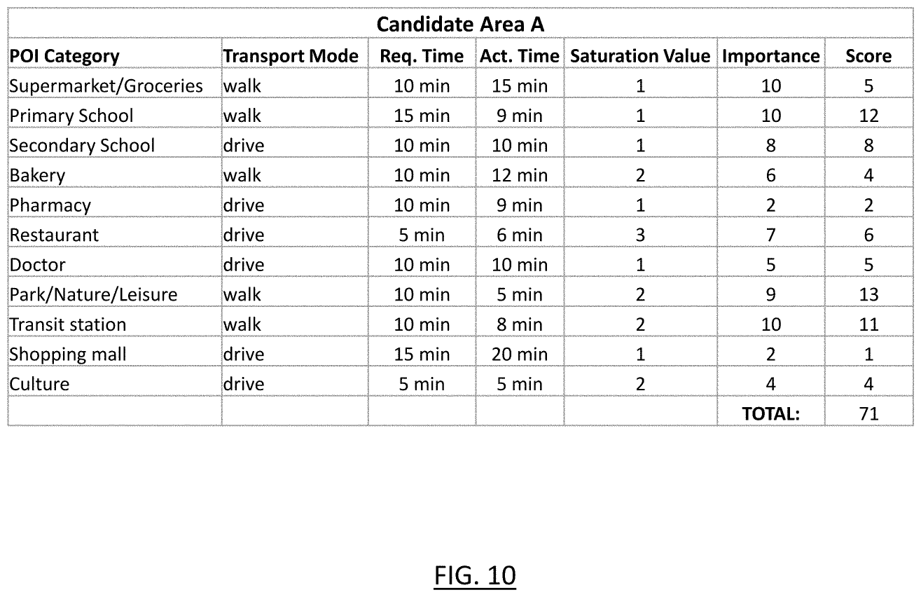

FIG. 10 illustrates another example embodiment where instead of a binary determination of whether an area meets or does-not-meet a certain time-proximity requirement for a point-of-interest or point-of-interest category, certain embodiments employ a scoring method using a degree of compliance with a point-of-interest requirement table. As illustrated, the table reflects the scoring for a particular candidate area. The point-of-interest categories, transport modes, and time (shown as requested time or “req. time”) are equivalent to that of FIG. 9. However, an actual time (shown as “act. time”) is shown reflecting how long the travel time is to a point-of-interest in the respective point-of-interest category from the candidate area. While a supermarket is not within a 10-minute walk of the candidate area, there is one available within a 15-minute walk, such that a partial credit can be afforded to the point-of-interest category (a score of 5 rather than 10 corresponding to the importance). This partial credit may diminish as the actual time is longer than the requested time. For example, an actual time of 50% greater than a requested time may result in a diminishing of the score by 50%, while an actual time of 100% greater than a requested time may result in diminishing of the score by 100% and affording zero credit for the grocery store that is a 20-minute walk away.

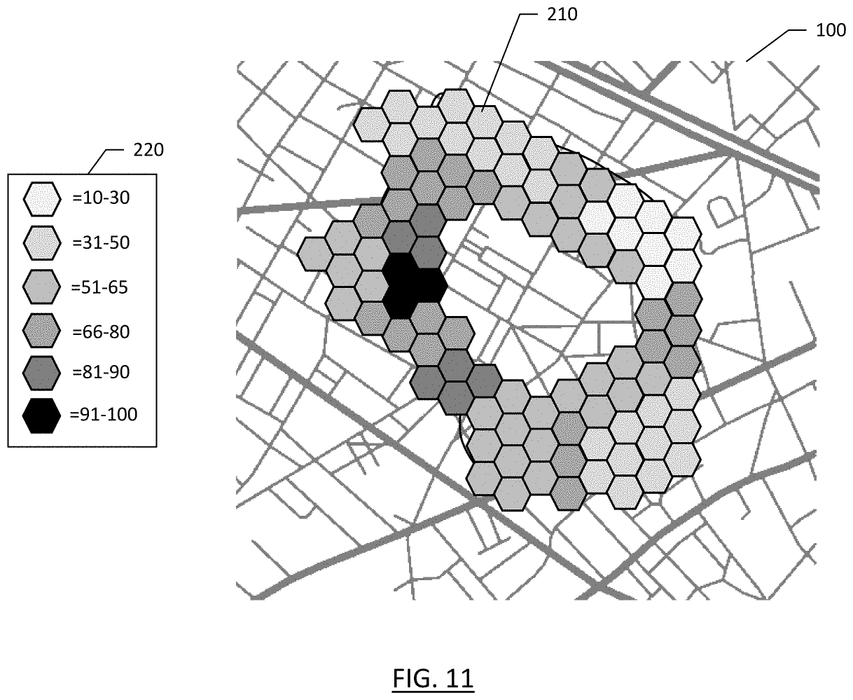

FIG. 11 illustrates the example embodiment of FIG. 6 with the polygon areas 210 defining candidate areas shaded to reflect their respective scores. The key 220 of the illustrated embodiment reflects the shading as it correlates to the scores. The scores may be normalized based on the maximum and minimum scores of the candidate areas for ease of presentation and uniformity across different cities and locations. The map of the geographical area 100 shown in FIG. 11 can be presented on a graphical user interface (e.g., user interface 28 of FIG. 2) to provide a user with a graphical depiction of candidate areas that are most desirable for location of a residence based on the point-of-interest criteria specific to that user.

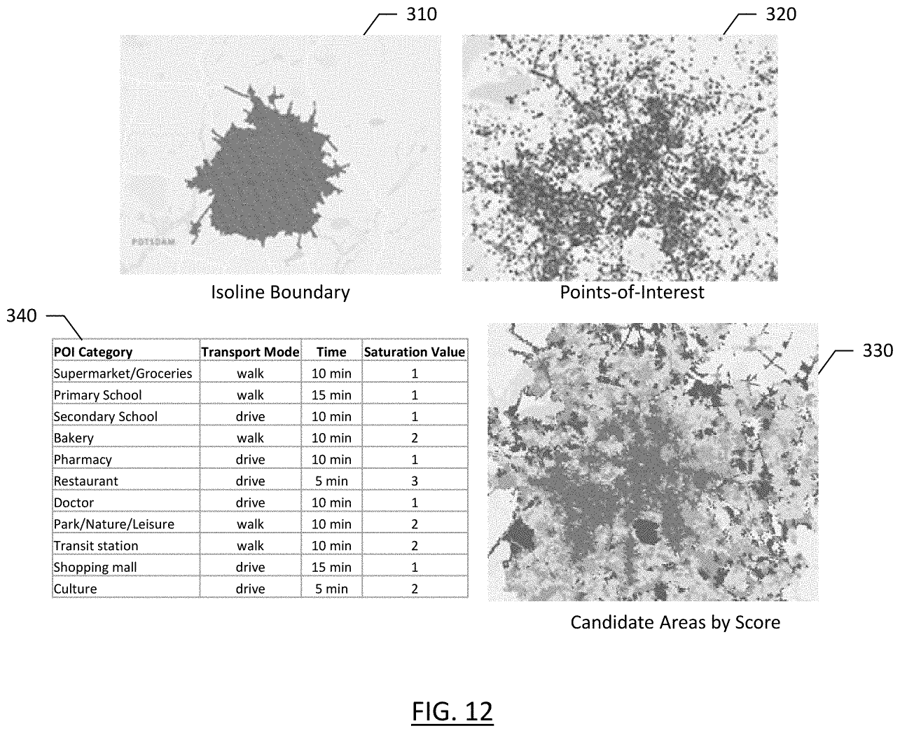

FIG. 12 illustrates another example of a graphical user interface depicting a point-of-interest requirement table 300 and an isoline boundary map 310 that indicates the areas that at least meet a minimum requirement, such as areas that are commutable to a user's place of work. A map of points-of-interest 320 is shown illustrating all of the different points-of-interest for a variety of point-of-interest categories that are stored in the map data. The points-of-interest may be color coded by category. Using the point-of-interest requirement table 300, the isoline boundary, and the points-of-interest in the map data, candidate areas can be generated by sectioning of the area within the isoline boundary into polygons, and scores generated for each of those polygons giving the candidate areas by score 330 similar to the image in FIG. 12. These candidate areas by score can be color coded based on their scores to identify candidate areas where it would be desirable to establish residence.

While example embodiments described herein have focused on establishing a residence from which a user may commute to work, embodiments can further be employed for identifying short-term lodging, such as hotels or short term rentals. The point-of-interest categories and importance or weights may differ based on a purpose of a short-term stay, where a user may be visiting for vacation. In such an embodiment, school locations and work locations can be ignored or given a weight of zero such that other point-of-interest categories can be prioritized, such as restaurants, culture, leisure, etc. Users may more heavily weight specific point-of-interest categories based on their type of travel. For example, in New York City, if a user is visiting to attend Broadway shows, a “culture” point-of-interest category may be given a high weight, or even a more specific point-of-interest category of theater may be included with a high weight. This would result in locations closer to Broadway scoring higher for the specific purpose of the user's trip.

Embodiments described herein can optionally be used to identify investment properties or locations where a user may wish to build, purchase, or lease property. Such embodiments may not employ the user mobility data of example embodiments described above; however, users may tailor their point-of-interest categories according to a type of area they are seeking. For example, if a user is interested in purchasing a single family home, they may wish to prioritize walkability to school and a grocery store, while other points-of-interest such as restaurants may be important, but have a lower importance weight.

Embodiments described herein can further guide a property owner on price points for rental properties. Often candidate areas that have a high score for a particular point-of-interest requirement table are grouped somewhat closely together. However, outlier locations can also be desirable as they may have access to a transit hub that renders them closer to various points-of-interest by transit. These candidate areas may have less desirable candidate areas surrounding them as they are not as easily accessible to the same points-of-interest. The rental rates for the surrounding candidate areas may be lower than what the candidate areas proximate the transit hub should command as can be evidenced by relatively higher candidate area scores for a point-of-interest requirement table. Thus, a property owner may use embodiments described herein to help guide rental prices for a given location.

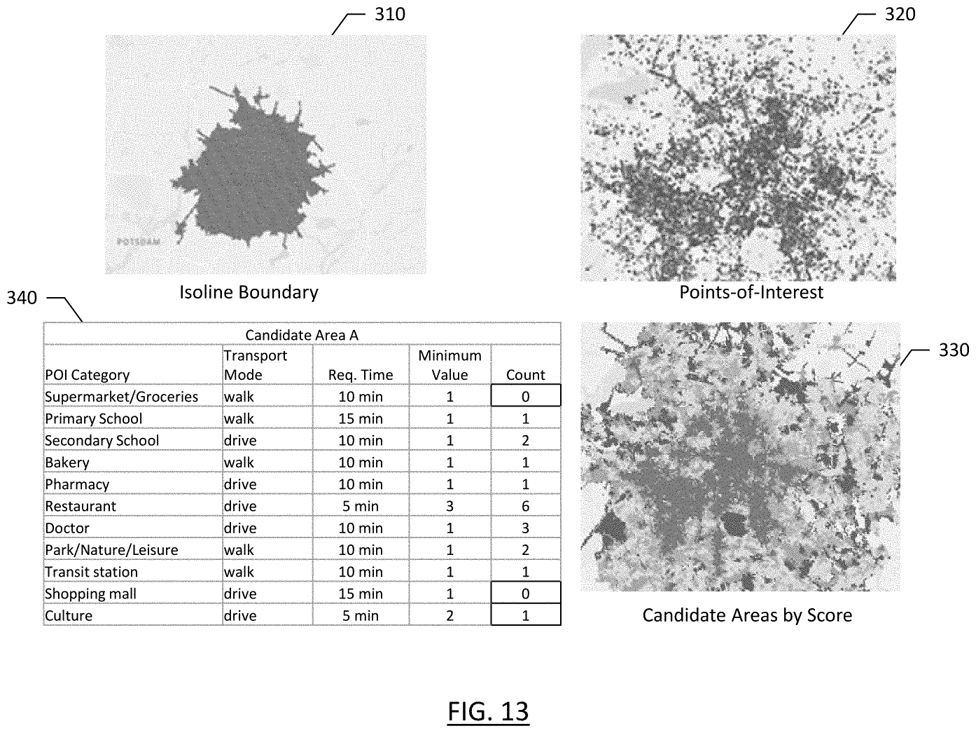

In addition the example use cases above, embodiment may be employed to identify candidate areas whose scores relating to point-of-interest category requirements can be improved, together with ways in which those candidate areas can be improved. According to an example embodiment, a candidate areas are identified and point-of-interest categories that are deficient can be determined that indicate a potential need for a point-of-interest in a deficient category. FIG. 13 illustrates a user interface similar to that of FIG. 12; however, the table 340 includes a count of the points-of-interest on a per-category basis relative to a “minimum value” for those points-of-interest to achieve a satisfactory score for the point-of-interest category. The “count” column indicates the number of points-of-interest of the particular category in the candidate area represented by the table. As shown, there is a deficiency in supermarkets, shopping malls, and cultural points-of-interest. This information can be used to identify locations for a new supermarket that can benefit an underserved community.

The user interface examples of FIGS. 12 and 13 can additionally be employed for user manipulation to tailor a search specifically to what the user is looking for. For example, a user may want a location (e.g., for residence and/or for temporary lodging) that has a wide array of restaurants available close by. While a first density of restaurants may be considered sufficient in a baseline standard for restaurant availability, the user may want twice as many restaurants available within a predetermined walking distance. In such an embodiment, the user may use the table of FIG. 13, or a user interface element for interaction therewith, to dial in a count of restaurants that the user wants available, a particular mode of transport, and a time to reach those restaurants. This can help specifically identify a location that fits the unique requests of a user. Such user manipulation to tailor a search specifically to their preferences can be employed for any point-of-interest category or categories to better identify the areas that a specific user will prefer.

Embodiments that provide an indication of deficiencies in certain point-of-interest categories are not as straightforward as identifying a geographic dispersion of certain types of points-of-interest as accessibility in one area may be different from accessibility in another. For example, a grocery store proximate a transit hub may be able to adequately serve numerous candidate areas as the grocery store is within a predetermined distance/travel time by transit. While a grocery store in a suburban area with little transit access may be within the required travel time of a very limited number of people or within one or only a few candidate areas. Thus, embodiments described herein provide point-of-interest category availability for a candidate area and point-of-interest category deficiencies of an area, and such information can be implemented into a variety of practical applications as described in the embodiments above.

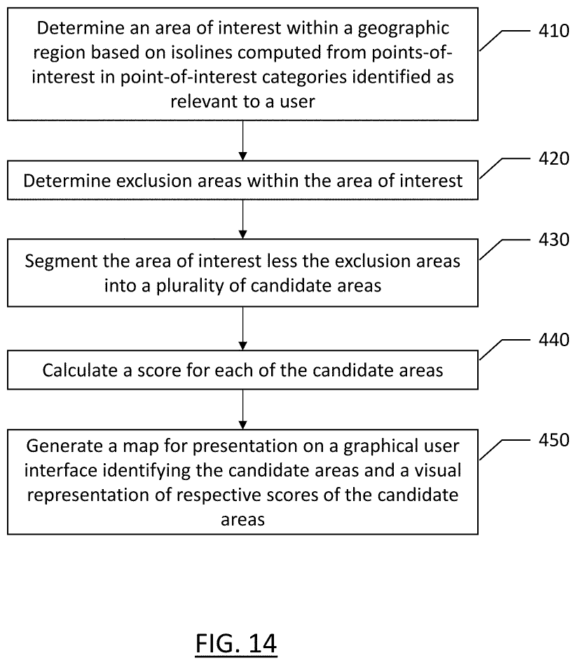

FIG. 14 illustrates a flowchart of a method for generating scores for candidate areas for property locations based on user preferences according to an example embodiment of the present disclosure. Areas of interest within a geographic region are determined at 410 based on isolines computed from points-of-interest in point-of-interest categories identified as relevant to a user. Exclusion areas within the area of interest are determined at 420. These represent areas not to be considered for candidate areas. The area of interest less the exclusion areas are segmented into a plurality of candidate areas at 430. At 440, a score is calculated for each candidate area, where the score for a candidate area is determined based on a subset of points-of-interest in the point-of-interest categories satisfying point-of-interest category-specific travel times relative to the candidate area established by isolines for the points-of-interest of the subset of points-of-interest. At 450, a map is generated for presentation on a graphical user interface identifying the candidate areas and a visual representation of respective scores of the candidate areas.

As described above, FIG. 14 illustrates a flowchart of apparatuses 20, methods, and computer program products according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIG. 14 above may comprise a processor (e.g., the processor 22) configured to perform some or each of the operations (410-450) described above. The processor may, for example, be configured to perform the operations (410-450) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 410-450 may comprise, for example, the processor 22 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least:
determine an area of interest within a geographic region based on isolines computed from points-of-interest in point-of-interest categories identified as relevant to a user;
determine exclusion areas within the area of interest;
segment the area of interest less the exclusion areas into a plurality of candidate areas;
calculate a score for each of the candidate areas, wherein the score for a candidate area is determined based on a subset of points-of-interest in the point-of-interest categories satisfying point-of-interest category-specific travel times relative to the candidate area established by isolines for the points-of-interest of the subset of points-of-interest; and
generate a map for presentation on a graphical user interface identifying the candidate areas and a visual representation of respective scores of the candidate areas.

2. The apparatus of claim 1, wherein the exclusion areas within the area of interest comprise areas exceeding a maximum average price per unit area for at least one of residential rental rates or residential property prices.

3. The apparatus of claim 1, wherein the exclusion areas within the area of interest comprise areas defined by map layers in map data, wherein the areas defined by map layers include one or more of: areas exceeding a maximum average ambient noise, areas exceeding a maximum average crime rate, areas failing to meet minimum average air quality standards, or areas zoned other than residential.

4. The apparatus of claim 1, wherein the point-of-interest categories identified as relevant to a user are identified based on historic mobility data of the user.

5. The apparatus of claim 1, wherein causing the apparatus to determine the area of interest within a geographic region based on isolines computed from points-of-interest in point-of-interest categories identified as relevant to the user comprises causing the apparatus to determine the area of interest within a geographic region based on isolines computed from points-of-interest in point-of-interest categories identified as relevant to the user and one or more individuals associated with the user.

6. The apparatus of claim 5, wherein the point-of-interest categories identified as relevant to the user and one or more individuals associated with the user are identified based on historic mobility data of the user and the one or more individuals associated with the user.

7. The apparatus of claim 1, wherein causing the apparatus to calculate the score for each of the candidate areas further comprises causing the apparatus to:
generate a weight for each point-of-interest category based on user preferences, wherein point-of-interest categories having a higher weight have greater influence on the score.

8. The apparatus of claim 7, wherein the apparatus is further caused to:
determine the weight for each point-of-interest category based on historic mobility data for the user.

9. The apparatus of claim 1, wherein point-of-interest category-specific travel times relative to the candidate area further comprise point-of-interest category-specific travel times by point-of-interest category-specific travel modes, wherein point-of-interest category-specific travel modes comprise one or more of walking, driving, using public transportation, cycling, or a combination thereof.

10. The apparatus of claim 1, wherein causing the apparatus to generate a map for presentation on a graphical user interface identifying the candidate areas and a visual representation of respective scores of the candidate areas comprises causing the apparatus to:
generate a map of the geographic region including an overlay of the candidate areas within the area of interest; and
visually distinguish each candidate area based on a respective score for the respective candidate area, where visual distinction includes one or more of: a color, a shade, or a transparency of the candidate area.

11. The apparatus of claim 10, wherein the apparatus is further configured to:
provide visual indications of points-of-interest in the point-of-interest categories identified as relevant to the user.

12. The apparatus of claim 11, wherein the apparatus is further caused to, in response to selection of a first candidate area, provide visual distinction of the points-of-interest in the point-of-interest categories identified as relevant to the user that contributed to the respective score for the first candidate area.

13. A computer program product comprising at least one non-transitory computer-readable storage medium having computer-executable program code instructions stored therein, the computer-executable program code instructions comprising program code instructions to:
determine an area of interest within a geographic region based on isolines computed from points-of-interest in point-of-interest categories identified as relevant to a user;
determine exclusion areas within the area of interest;
segment the area of interest less the exclusion areas into a plurality of candidate areas;
calculate a score for each of the candidate areas, wherein the score for a candidate area is determined based on a subset of points-of-interest in the point-of-interest categories satisfying point-of-interest category-specific travel times relative to the candidate area established by isolines for the points-of-interest of the subset of points-of-interest; and
generate a map for presentation on a graphical user interface identifying the candidate areas and a visual representation of respective scores of the candidate areas.

14. The computer program product of claim 13, wherein the exclusion areas within the area of interest comprise areas exceeding a maximum average price per unit area for at least one of residential rental rates or residential property prices.

15. The computer program product of claim 13, wherein the exclusion areas within the area of interest comprise areas defined by map layers in map data, wherein the areas defined by map layers include one or more of: areas exceeding a maximum average ambient noise, areas exceeding a maximum average crime rate, areas failing to meet minimum average air quality standards, or areas zoned other than residential.

16. A method comprising:
determining an area of interest within a geographic region based on isolines computed from points-of-interest in point-of-interest categories identified as relevant to a user;
determining exclusion areas within the area of interest;
segmenting the area of interest less the exclusion areas into a plurality of candidate areas;
calculating a score for each of the candidate areas, wherein the score for a candidate area is determined based on a subset of points-of-interest in the point-of-interest categories satisfying point-of-interest category-specific travel times relative to the candidate area established by isolines for the points-of-interest of the subset of points-of-interest; and
generating a map for presentation on a graphical user interface identifying the candidate areas and a visual representation of respective scores of the candidate areas.

17. The method of claim 16, wherein the exclusion areas within the area of interest comprise areas exceeding a maximum average price per unit area for at least one of residential rental rates or residential property prices.

18. The method of claim 16, wherein the exclusion areas within the area of interest comprise areas defined by map layers in map data, wherein the areas defined by map layers include one or more of: areas exceeding a maximum average ambient noise, areas exceeding a maximum average crime rate, areas failing to meet minimum average air quality standards, or areas zoned other than residential.

19. The method of claim 16, wherein the point-of-interest categories identified as relevant to a user are identified based on historic mobility data of the user.

20. The method of claim 16, wherein determining the area of interest within a geographic region based on isolines computed from points-of-interest in point-of-interest categories identified as relevant to the user comprises determining the area of interest within a geographic region based on isolines computed from points-of-interest in point-of-interest categories identified as relevant to the user and one or more individuals associated with the user.
